(19) United States
(12) Patent Application Publication
(10) Pub. No.: US 2008/0002402 A1
(43) Pub. Date: Jan. 3, 2008

(54) DENTAL ILLUMINATION DEVICE AND METHOD

(76) Inventor: Michael Nicholas Mandikos, Chelmer (AU)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/776,204

(22) Filed: Jul. 11, 2007

Related U.S. Application Data
(63) Continuation of application No. PCT/AU2006/000047, filed on Jan. 16, 2006.

(30) Foreign Application Priority Data
Jan. 14, 2005 (AU) AU2005900148

(51) Int. Cl. F21V 9/00; A61C 1/00

(52) U.S. Cl. 362/231; 362/573; 433/29

(57) ABSTRACT

A dental illumination device is provided that comprises a plurality of light-emitting diodes capable of emitting light of selected wavelengths that do not activate initiator molecules contained within dental restorative material such as dental composite, or at an intensity which is insufficient to initiate substantial polymerization of the dental restorative material. Typically, the dental illumination device produces light having wavelengths not in a range selected from 400 nm to 500 nm, 350 nm to 470 nm and below 350 nm to 420 nm. The dental illumination device may further comprise a switch that allows the aforementioned wavelengths to be switched off or reduced in intensity as required. The dental illumination device may operate as a stand-alone unit or may be fitted to an existing dental light.

### RELATED APPLICATIONS

This application is a continuation of International Application PCT/AU2006/000047, with an international filing dated of Jan. 16, 2006, which claims priority to Australian Patent Application AU2005900148, filed Jan. 14, 2005, both of which are hereby incorporated by reference in their entirety.

### FIELD OF THE INVENTION

THIS INVENTION relates to an illumination device and method that prevents premature photo-polymerization of dental restorative materials. More particularly, this invention relates to a device and method for illumination of a dental workspace and/or oral cavity during application of a composite filling to prevent premature polymerization of the composite filling.

### BACKGROUND OF THE INVENTION

Modern general dental practice involves the use of restorative materials such as so called “white filling” materials, which comprise ceramics, glass-ionomer cement restoratives and composite resins. This latter group, the composite resin materials (“composites”), are frequently used by dentists for restoring anterior and posterior teeth, with “tooth-coloured fillings”.

Typically, dental restorative materials such as composites, are dispensed in an unset phase as a viscous paste which can be puttied or moulded into place to restore a missing portion of a tooth or otherwise fill a tooth cavity, crack or crevice. Chemically, the paste is made of monomeric molecules which undergo photo-polymerisation in order to set into a hard “set phase” filling.

Polymerisation requires “initiator” molecules that initiate the chemical reaction. In order to initiate the polymerisation of a composite from a paste to a set phase, electromagnetic energy is applied to the composite paste to activate the initiator molecules contained within the paste. Once these initiator molecules are energised by absorbing some of the electromagnetic energy, they react to commence the polymerisation process within the composite paste, resulting in the setting of the paste. The most commonly used photo-initiator molecules are based on camphorquinones, which are activated by blue light. The range of absorption of blue light by these initiator molecules is limited to between approximately 400-500 nm wavelengths with the peak absorption occurring around 465 nm.

Another photo-initiator is phenyl-propanedione (or PPD), which has an ability to absorb light of wavelengths less that 350 nm (near ultra-violet range) to about 470 nm, with its peak absorption occurring at 390 nm.

Another even less common photo-initiator used in some dental materials is called Lucerin TPO which is also in the lower end of wavelengths, starting with absorption ability below 350 nm, peaking at about 370 nm and ceasing to absorb light with wavelengths above 420 nm.

The blue light typically used in composite dentistry is produced or filtered down to a wavelength in a range that peaks as close as possible to 465 nm, given that the photo-initiator molecules within the composite paste are usually based on camphorquinone chemistry.

During the placement of a filling into a tooth by a dentist, the composite is dispensed from light-protective packaging, either onto a pad or directly into the tooth. If dispensed onto a pad, a bulk amount is usually dispensed onto the pad and the dentist will then take small increments from this bulk amount and transfer these increments into the tooth. The bulk amount on the pad is thus subject to exposure to ambient light (which will include light of 465 nm wavelength) in the dentist's workspace and will polymerize upon prolonged exposure to light, the rate of polymerization dependent upon the intensity of the ambient light. Once polymerised, the composite is useless to the dentist. Covering the composite on the pad with a light-proof cover is thus a common practice, and many devices are available for this purpose.

When working in the intra-oral environment, the dentist uses an overhead operating light to illuminate the oral cavity. This light is normally a focussed spot light of quite high intensity and provides bright white light illumination into the mouth. The dentist is thus able to readily see the teeth and tissues within the oral cavity. However, when placing composites into teeth, the operating light is so bright that it will start to activate the polymerisation process of the composite. This is a common and very real problem for dentists, and can happen in even the very first few seconds of the composite being exposed to light (depending on the brightness of the operating light). The composite becomes unmanageable if it begins to harden during placement, and the consequences on the physical properties of the final filling are very deleterious if the composite is partly polymerising during its placement.

To prevent this problem occurring, dentists often turn off their operating light. This prevents the composite from setting during placement, but makes it very difficult to see the tooth or tissue being treated. The subsequent eye strain is tiring for the dentist and the inability to properly see the relevant tooth or cavity to be filled can lead to a significant drop in the quality of the service being provided to the patient.

Dental composite manufacturers have also realised that this is a significant problem in composite dentistry and have begun to alter the levels of initiator molecules that they include in the composites that they make. Their aim has been to decrease the levels of initiator to the point that the composite is less sensitive to ambient light. In reality, the composite is not resistant to polymerisation by ambient light, but it might take a slightly longer exposure to ambient light to effect premature polymerisation. However, there is a limit to how little initiator can be incorporated into the composite as if there is too little, there may not be enough to effect adequate polymerisation by the dentist clinically when he or she shines their blue light source onto the filling to make it set. Or, there may be enough initiator, but it may take an unacceptably long period of time of blue light exposure to make the filling set.

In light of the foregoing, proposed solutions to the problem of light-activated premature polymerization of dental composites have been problematic.

Firstly, reduced or absent illumination of the oral cavity during application of a composite filling compromises the ability of a dentist to operate effectively and efficiently.

Secondly, reduced level of polymerization initiator in the dental composite can compromise the quality of the composite filling and also does not eliminate the problem of at least some premature polymerization occurring.

With these problems in mind, German Patent Application DE 199 10 126 describes the use of gas discharge lamps for producing light of wavelengths that do not initiate composite polymerization, or filters which remove such wavelengths from polychromatic light.

A dental light filter is also described in International Publication WO98/10220, which filters light in the wavelength range 400-520 nm to thereby reduce premature composite polymerization.

### SUMMARY OF THE INVENTION

Notwithstanding prior art attempts to deal with the problem of premature polymerization of dental composites, there is still no dental illumination source that provides satisfactory illumination to allow a dentist to work safely and efficiently while avoiding premature polymerization of dental composites. In this regard, prior art light filters significantly reduce light intensity while gas discharge lamps are expensive and complicated due to the need to provide appropriate gas mixtures.

The present invention is therefore broadly directed to an illumination device that is capable of emitting light of selected wavelengths that do not activate initiator molecules contained within dental restorative material, or at an intensity which is insufficient to initiate substantial polymerization of a dental restorative material.

In one broad form, the invention provides an illumination device comprising an illumination source which comprises a plurality of light emitting elements that are incapable of emitting light at selected wavelengths that activate initiator molecules contained within dental restorative material, or which emit light of said selected wavelengths at an intensity which is insufficient to initiate substantial polymerization of a dental restorative material.

Suitably, in use the illumination device provides sufficient light to illuminate an oral cavity and/or dental workspace notwithstanding the selective absence of, or reduction in, light emitted at wavelengths that activate initiator molecules contained within dental restorative material.

In another broad form, the invention provides a method of applying a dental restorative material or illuminating a dental workspace under illumination conditions that do not activate initiator molecules contained within dental restorative material and/or do not initiate substantial polymerization of said dental restorative material.

In a first aspect, the invention provides an illumination device comprising an illumination source that is capable of emitting light of a wavelength not in a range selected from the group consisting of:

400 to 500 nm;

350 to 470 nm; and

below 350 to 420 nm.

Preferably, with respect to (a), the illumination source is capable of emitting light of a wavelength not in the range 420-480 nm.

More preferably, the illumination source is capable of emitting light of a wavelength not in the range 460-470 nm.

Advantageously, the illumination source is capable of emitting light of a wavelength not 465 nm.

Preferably, with respect to (b), the illumination source is capable of emitting light of a wavelength not in the range 360-420 nm.

More preferably, the illumination source is capable of emitting light of a wavelength not 380-400 nm.

Advantageously, the illumination source is capable of emitting light of a wavelength not 390 nm.

Preferably, with respect to (c), the illumination source is capable of emitting light of a wavelength not in the range below 350-400 nm.

More preferably, the illumination source is capable of emitting light of a wavelength not 360-380 nm.

Advantageously, the illumination source is capable of emitting light of a wavelength not 370 nm.

In a more preferred embodiment, the illumination source comprises a plurality of light emitting elements, one or more of which emit light of a particular wavelength not in the range 460-470 nm.

In a particularly preferred form of these aspects, the light emitting elements are light-emitting diodes (LEDs).

In a less preferred embodiment, the illumination source comprises a filter which substantially prevents emission of light having a wavelength in the range 400-500 nm.

In a second aspect, the invention provides a method of applying a dental restorative material including the step of applying the dental restorative material to a tooth when the oral cavity is illuminated with light does that not activate initiator molecules contained within dental restorative material, or which does not initiate substantial polymerization of a dental restorative material.

Preferably, the light comprises one or more wavelengths not in a range selected from the group consisting of:

400 to 500 nm;

350 to 470 nm; and

below 350 to 420 nm.

Preferably, with respect to (a), the wavelength is not in the range 420-480 nm.

More preferably, the wavelength is not in the range 460-470 nm.

Advantageously, the wavelength is not 465 nm.

Preferably, with respect to (b), the wavelength is not in the range 360-420 nm.

More preferably, the wavelength is not 380-400 nm.

Advantageously, the wavelength is not 390 nm.

Preferably, with respect to (c), the wavelength is not in the range 350-400 nm.

More preferably, the wavelength is not in the range 360-380 nm.

Advantageously, the wavelength is not 370 nm.

In a third aspect, the invention provides a method of illuminating a dental workspace including the step of providing illumination with light that does not activate initiator molecules contained within dental restorative material, or which does not initiate substantial polymerization of a dental restorative material.

Preferably, the light comprises one or more wavelengths not in a range selected from the group consisting of:

400 to 500 nm;

350 to 470 nm; and

below 350 to 420 nm.

Preferably, with respect to (a), the wavelength is not in the range 420-480 nm.

More preferably, the wavelength is not in the range 460-470 nm.

Advantageously, the wavelength is not 465 nm.

Preferably, with respect to (b), the wavelength is not in the range 360-420 nm.

More preferably, the wavelength is not in the range 380-400 nm.

Advantageously, the wavelength is not 390 nm.

Preferably, with respect to (c), the wavelength not in the range 350-400 nm.

More preferably, the wavelength is not in the range 360-380 nm.

Advantageously, the wavelength is not 370 nm.

Preferably, according to the aforementioned aspects, illumination is provided when applying a composite to a tooth prior to polymerization of the composite or dental restorative material.

According to the aforementioned aspects, the illumination source may lack any light emitting elements (e.g. LEDs) that are capable of emitting light of a wavelength that activates initiator molecules contained within dental restorative material.

Alternatively, the illumination source may have relatively fewer light emitting elements (e.g. LEDs) that are capable of emitting light of a wavelength that activates initiator molecules contained within dental restorative material, wherein said wavelength(s) is/are emitted at an intensity which is insufficient to initiate substantial polymerization of a dental restorative material.

In another embodiment, the illumination source may have light emitting elements (e.g. LEDs) capable of emitting light of a wavelength that activates initiator molecules contained within dental restorative material, wherein a switching means is provided to selectively switch off these light emitting elements and/or reduce their intensity as required.

Throughout this specification, unless the context requires otherwise, the words “comprise”, “comprises” and “comprising” will be understood to imply the inclusion of a stated integer or group of integers but not the exclusion of any other integer or group of integers.

### BRIEF DESCRIPTION OF THE DRAWING

In order that the present invention may be more readily understood and placed into practical effect, preferred embodiments of the invention will be described, by way of example only, with reference to the accompanying drawing in which:

FIG. 1 shows a schematic representation of a dental illumination device; and

FIG. 2 shows a side view of an illumination device comprising a light focusing means.

### DETAILED DESCRIPTION OF THE INVENTION

The present invention provides an illumination device that is capable of emitting light of selected wavelengths that do not activate initiator molecules contained within dental restorative material.

The illumination device of the invention may be used in a dentist's workspace or may be used in a factory, dispensary or other environment where photocurable materials (whether for dental or other use) are prepared, handled, packaged and/or dispensed.

In a preferred from, the invention provides a dental illumination device for use in a dental workspace which is capable of emitting light of a wavelength not in the range 400-500 nm, and yet is still acceptable to the human eye for illumination both in terms of adequate intensity and trueness of colour and contrast.

Preferably, the illumination device of the invention comprises a plurality of Light Emitting Diodes (LED).

In a particularly preferred form, the plurality of LEDs comprise one or more LEDs that emit light of a particular wavelength not in the range 460-470 nm, or more particularly not 465 nm light.

According to this preferred form, the illumination device and method of the invention are applicable to dental restorative materials that include camphorquinone-based photo-initiators having peak light absorption around 465 nm.

However, it will be appreciated that the inventive concept is also applicable to or other photo-initiators that may come to be used in dentistry, including the currently less commonly used phenyl-propanedione (or PPD) and Lucerin TPO photoinitiators.

The wavelength of light emitted by an LED is in a tight band of a defined wavelength, thus a plurality of LEDs may be arranged so that light of suitable intensity and visibility (including but not limited to “near white” light), can be produced, without “stray” blue or near-blue light wavelengths being emitted.

Accordingly, with the vast array of LEDs now available (see for example http://www.superbrightleds.com/leds.htm), in one form the invention contemplates a dental illumination device comprising a plurality of High Intensity LEDs, one or more of which LEDs emit light of the different component colours of light (Violet, Indigo, Blue, Green, Yellow, Orange, Red), and focuses these into a single spot of illumination to create white or “near-white” light.

According to this embodiment, a switching means is provided for switching off one or more LEDs (e.g. wavelengths in the range 400-500 nm), thereby creating a dental light source specifically deficient in the wavelength of light to which composite initiator molecules are sensitive.

This light would effectively be white or “near-white” light, but in contrast to filtered light, would still be very bright, as less than about 1/7^{th} of the light intensity of the original source would have been removed as only one LED would be turned off without the removal of all lower wavelengths in the “near blue spectrum” (e.g. 465 nm) of light emission.

In another embodiment, said switching means is for reducing light output, which means facilitates selectively lowering the intensity of emission of a particular light (e.g. blue light in the range 400-500 nm) to thereby reduce the total output of that particular light over a time period.

Another form of this embodiment is a switching means that facilitates emission of intermittent “pulses” of a particular light (e.g. blue light in the range 400-500 nm) to thereby reduce the total output of that particular light over a time period.

Switching means may be provided as a manual switch mounted to the illumination device, as a switch operated by a remote control or as a “proximity” switch in the illumination device which, for example, comprises a motion detector to automatically operate said switching means.

In this regard, LEDs are presently available with different emission wavelengths within the same general colour band of light. For example, several Red LEDs exist which emit light in wavelengths of 627, 628, 630, 631 nm respectively, yet all are red-coloured light sources. Therefore, different LEDs could be used so that not all “blue-spectrum” light would need to be removed, but instead, only the blue LEDs which emit wavelengths within the specific peak absorption spectrum of the initiator molecule of composite would be removed. This means that the “wavelength-depleted light” that could be produced by placing specific LEDs in an array, could be very close to white light and thus provide good, high contrast and bright viewing for the dentist.

By way of example, typical commercially available LEDs allow the following choices:

| | | |
|---|---|---|
| Ultraviolet (near) | 395 | nm |
| True Violet | 400-420 | nm |
| Violet | 405 | nm |
| Indigo | 430 | nm |
| Blue | 460-472 | nm |
| Turquoise | 495-505 | nm |
| Aqua | 505-507 | nm |
| Green | 524-525 | nm |
| Yellow | 588-595 | nm |
| Orange | 605-615 | nm |
| Red | 627-660 | nm |

LEDs are also made with varying light emission strengths, measured in millicandellas (mcd) and in Lumens (lm) for high intensity LEDs. Some coloured LEDs have greater mcd and lm values than other colours. Accordingly, it may be necessary to vary the number of LEDs for each particular wavelength or group of wavelengths to ensure an even light intensity blend. By way of example, Green LEDs are presently commercially available in light intensity outputs of luminous intensity 5000 mcd to 13000 mcd. Orange LEDs are typically available in brightness' of 4000 and 5000 mcd. Thus, the dental light source of the invention might require more orange LEDs than Green LEDs.

Further to this, the human eye is more sensitive to certain wavelengths of light, therefore more sensitive to certain colours. Specifically, it is most sensitive to Green-Yellow colours and least sensitive to Red. Thus it may be necessary to use more Red LEDs to compensate for this phenomenon.

Particularly high luminous density (lumens/mm²) LEDs are also available, such as the Luxeon™ LED from Lumileds Lighting, San Jose, Calif. USA, which have luminous densities as high as 20, 50 or up to 200 lumens/mm².

Notwithstanding the foregoing variables, it will be appreciated by a person skilled in the art that the number of LEDs and the respective wavelengths of each LED may be readily ascertained or tested to produce suitably visible light, such as but not including near white light, of a total luminous intensity which may be 50,000 mcd, 60,000 mcd, 100,000 mcd, 200,000 mcd, 300,000 mcd, 400,000 mcd, 500,000 mcd or more.

Accordingly, a non-limiting example of an LED array of the invention may comprise a total of 80-120 LEDs, each of approximately 5000 mcd luminous intensity.

In an alternative non-limiting example, fewer LEDs may be used, such as three to four high intensity Luxeon-style LEDs, each of a luminous density of 20 to 50 or more lm/mm².

Typically, the LEDs are arranged as an LED or diode array, whereby one or more arrays are provided in an illumination source.

An example of a conventional LED array is provided in published United States Patent Application 20040029069.

It will also be appreciated that LEDs can generate heat, particularly high luminous intensity/density LEDS, in which case a cooling means may be required.

One non-limiting example of a cooling means is a heatsink “slug” provided with the aforementioned Luxeon™ LED.

Cooling may also be achieved by using materials such as ceramics, for example alumina or silica, in the construction of the illumination device.

In other embodiments, a cooling means may be included in the form of a fan-driven air cooler to reduce heat within the illumination device.

A non-limiting example of a cooling means applicable to a conventional LED array is described in published United States Patent Application 20040185413.

LEDs generally operate on very low power consumptions (usually 20 mA per LED and up to 350 mA for higher intensity LEDs). Even if many LEDs were used in an array, the total power requirement would still be low. Thus, in principle a battery could be used as the power source, although this might not be practical for normal, all-day clinical use.

Preferably, the illumination device of the invention would be connected to 110-240V mains, and a step-down transformer would be used to lower the voltage to 12 or 24V. Then, depending on the size of the LED array, resistors would be placed in the circuit to limit the voltage.

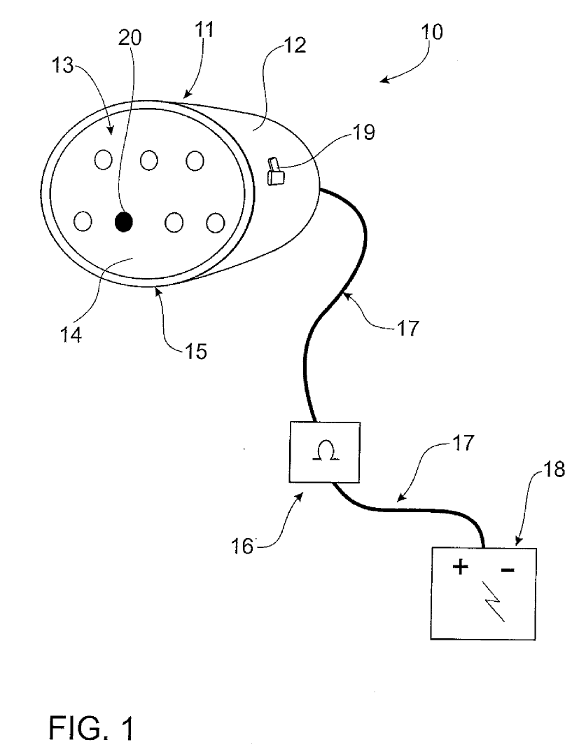

Referring to FIG. 1, dental illumination device 10 comprises illumination source 11 that comprises housing 12 having a plurality of LEDs 13 arrayed on reflective base 14 of reflector body 15. Illumination source 11 may comprise one or more LED arrays, each comprising as few as two (e.g. red and green) LEDs or up to seven LEDs 13, using the colours and wavelengths as hereinbefore described to produce white light, or near white light of suitable intensity. In this regard, the seven LEDs 13 shown in FIG. 1 could respectively be red, orange, yellow, green, blue, indigo and violet (i.e. wavelengths at least approximating those colours).

Referring again to FIG. 1, illumination source 11 is electrically connected to resistor(s) 16 via insulated electrical conduit 17 which is connectable to power source 18 via insulated electrical conduit 17, such as a 12 or 24V step down transformer. It will also be appreciated by persons skilled in the art that supply of electrical current may be regulated to thereby obtain a desired level of brightness.

Switch 19 is located on housing 12 and allows LED 20 emitting blue light (e.g. 460-470 nm light) to be switched on and off or to have its output reduced as required.

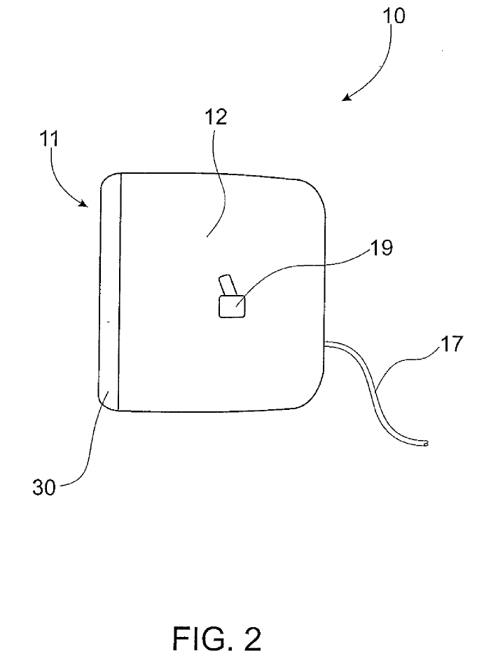

Referring now to FIG. 2, illumination device 10 may further comprise light focusing means 30, which may be in the form of a lens and/or collimator for example, to facilitate focusing of emitted light into a more confined or restricted path to thereby maximize intensity over an area of illumination.

In an alternative embodiment, rather than switching off or reducing the output of blue LED 20, “blue/indigo/violet” LEDs 13 could be selected so as to emit wavelengths which are not those that activate initiator molecules contained within dental restorative material (e.g. 465 nm). According to this embodiment, “near white” light could be emitted at all times during use without the need to switch off or reduce the output of “blue/indigo/violet” LED 20 when applying dental restorative material.

Alternatively, the LED array could include no “blue/indigo/violet” LEDs 20, or fewer “blue/indigo/violet” LEDs 20 so that the intensity of these emitted wavelengths of light is reduced to a level insufficient to initiate substantial polymerization of a dental restorative material.

An example of an appropriate formula (when using LEDs of the same light output capacity) for producing white light is a ratio of 2 parts blue to 5 parts red to 10 parts green.

In a non-limiting example, the illumination source could comprise a plurality of LEDs 13 that emit light with wavelengths or “colours” in the ratio 0-2 parts blue, 10 parts red and 20 parts green.

Illumination device 10 described in FIGS. 1 and 2 is a complete, stand-alone unit.

Alternatively, the LED illumination source 11 may be retro-fitted to an existing, conventional dental light, perhaps as a replacement “bulb”, to thereby replace the standard white light source.

In another alternative embodiment, the invention provides a dental illumination device 10 which is attachable, mountable or otherwise associable with an existing white light source.

According to this embodiment, a dentist continues to use the white light source except during application of a composite filling. At that time, the standard, white light source is switched off, and the “blue-light deficient” dental illumination device is used during application of a composite filling.

One advantage of the invention is that the illumination device will produce a clean, bright, white or near white light source of sufficient intensity to be useful in a dental workspace.

The resultant light would be closer to “white” in colour than conventional incandescent bulbs filtered with conventional filters, and so the dentist would be able to operate in a sufficiently bright field of view, and still see reasonably true colour. However, whichever blue wavelengths activate composite polymerization would be absent, such that the composite would remain unaffected.

Another advantage of the invention is that LEDs do not need high amounts of current compared to incandescent bulbs.

Yet another advantage of the invention is that LEDs do not have filaments that can burn out, so they will last considerably longer than incandescent light bulbs.

The invention also contemplates other embodiments of the inventive concept.

In one alternative embodiment, the invention provides an illumination device comprising a plurality of phosphor-coated LEDs.

In this regard, a “white LED” may be produced by coating a non-blue LED with phosphor. The non-blue light emitted excites the phosphor which then emits other wavelengths to produce resultant “near white” light. The phosphor coating could be applied so as to produce emitted “near white” light that is deficient in wavelengths in the blue range.

In another particular embodiment, the invention provides an illumination device that produces white light by focussing red and green light (e.g. LEDs) into a point light source, such as using a lens and/or collimating device, thereby omitting the blue light source all together. This illumination device could then be used as a substitute for, or “retro-fitted” to an overhead operating light.

Although the foregoing embodiments have been primarily described by way of LEDs as light emitting elements, it is possible that laser light technology may be applicable to the present invention by combining laser lights of selected wavelengths to produce a dental illumination device of the invention.

Throughout the specification the aim has been to describe the preferred embodiments of the invention without limiting the invention to any one embodiment or specific collection of features. It will therefore be appreciated by those of skill in the art that, in light of the instant disclosure, various modifications and changes can be made in the particular embodiments exemplified without departing from the scope of the present invention.

All computer programs, algorithms, patent and scientific literature referred to herein is incorporated herein by reference.

1. A dental illumination device comprising an illumination source which comprises a plurality of light emitting diodes that are incapable of emitting light at selected wavelengths that activate initiator molecules contained within dental restorative material, or which emit light of said selected wavelengths at an intensity which is insufficient to initiate substantial polymerization of a dental restorative material.

2. The dental illumination device of claim 1, wherein the illumination source further comprises one or more light emitting elements that are capable of emitting light of a wavelength that activates initiator molecules contained within dental restorative material and wherein the illumination device further comprises a switching means that is operable to switch off said one or more light emitting elements.

3. The dental illumination device of claim 1, wherein the illumination source further comprises one or more light emitting elements that are capable of emitting light of a wavelength that activates initiator molecules contained within dental restorative material and wherein the illumination device further comprises a switching means that is operable to reduce the intensity of light emitted by said one or more light emitting elements.

4. The dental illumination device of claim 1, wherein light emitting elements that are capable of emitting light of a wavelength that activates initiator molecules contained within dental restorative material are absent from said illumination device.

5. The dental illumination device of claim 1, wherein the illumination source further comprises one or more light emitting elements that are capable of emitting light of a wavelength that activates initiator molecules contained within dental restorative material but at an intensity which is insufficient to initiate substantial polymerization of said dental restorative material.

6. The dental illumination device of claim 1, comprising an illumination source that comprises a plurality of light emitting diodes that are incapable of emitting light of a wavelength in a range selected from the group consisting of:
(a) 400 to 500 nm;
(b) 350 to 470 nm; and
(c) below 350 to 420 nm;
or which are capable of emitting light at one or more of said wavelengths at an intensity which is insufficient to initiate substantial polymerization of said dental restorative material.

7. The dental illumination device of claim 6, wherein the illumination source is incapable of emitting light of a wavelength in the range 420-480 nm.

8. The dental illumination device of claim 7, wherein the illumination source is incapable of emitting light of a wavelength in the range 460-470 nm.

9. The dental illumination device of claim 8, wherein the illumination source is incapable of emitting light of a wavelength at 465 nm.

10. The dental illumination device of claim 6, wherein the illumination source is incapable of emitting light of a wavelength in the range 360-420 nm.

11. The dental illumination device of claim 10, wherein the illumination source is incapable of emitting light of a wavelength in the range 380-400 nm.

12. The dental illumination device of claim 11, wherein the illumination source is capable of emitting light of a wavelength 390 nm.

13. The dental illumination device of claim 6, wherein the illumination source is incapable of emitting light of a wavelength in the range below 350-400 nm.

14. The dental illumination device of claim 13, wherein the illumination source is incapable of emitting light of a wavelength 360-380 nm.

15. The dental illumination device of claim 14, wherein the illumination source is incapable of emitting light of a wavelength of 370 nm.

16. A method of applying a dental restorative material including the step of applying the dental restorative material to a tooth when the oral cavity is illuminated with light produced by the dental illumination device of claim 1.

17. A method of illuminating a dental workspace including the step of providing illumination with light produced by the illumination device of claim 1.

18. The method of claim 17, wherein illumination is provided when applying a composite to a tooth prior to polymerization of the dental restorative material.

19. A method of applying a dental restorative material including the step of applying the dental restorative material to a tooth when the oral cavity is illuminated with light produced by the dental illumination device of claim 2.
